(19) United States
(12) Patent Application Publication
(10) Pub. No.: US 2023/0155253 A1
(43) Pub. Date: May 18, 2023

(54) ASSYMETRIC POROUS MEMBRANE

(71) Applicant: Celgard, LLC, Charlotte, NC (US)

(72) Inventors: Wenbin Yin, Charlotte, NC (US); Daniel R. Alexander, Matthews, NC (US); Stefan Reinartz, Waxhaw, NC (US); Kang Karen Xiao, Mississauga (CA); Hisashi Takeda, Charlotte, NC (US); Allen M. Donn, Rock Hill, SC (US)

(21) Appl. No.: 17/918,571

(22) PCT Filed: Apr. 16, 2021
(86) PCT No.: PCT/US2021/027585

§ 371 Date: Oct. 13, 2022

Related U.S. Application Data
(60) Provisional application No. 63/011,317, filed on Apr. 17, 2020.
(60) Provisional application No. 63/043,797, filed on Jun. 25, 2020.

(51) Int. Cl. H01M 50/489; H01M 50/457; H01M 50/417; H01M 50/434

(52) U.S. Cl. CPC H01M 50/489; H01M 50/417; H01M 50/434; H01M 50/457

(57) ABSTRACT

Disclosed herein is an asymmetric porous membrane having two outer layers and at least one inner layers. The outer layers may be asymmetric in thickness, pore size, porosity, tortuosity, or combinations thereof. In some embodiments, the asymmetric porous membrane has two outer layers and no inner layers. The thickness of one of the outer layers to the other of the outer layers is from 1.1 to 25:1, preferably from 1.1:1 to 10:1, 1.1:1 to 5:1 or 4:1 to 10:1. In some embodiments, both outer layers are PP-containing layers and in some embodiments, one outermost layer may be a PE-containing layer and the other may be a PP-containing layer. The asymmetric porous membrane may be used as or to make a battery separator. In some embodiments, the battery separator may include an asymmetric porous membrane having the thinner of the two outer layers or the layer facing the anode coated with a coating such as a ceramic coating. The battery separator may be used in a liquid electrolyte secondary battery. In the battery, the thicker of the outer layers and/or the PP-containing layer faces or is closest to the cathode and the thinner of the two outer layers and/or the PE-containing layer faces or is closest to the anode. The outer layer facing the anode may be coated with a coating such as a ceramic coating. The battery separators described herein may have electrochemical stability voltage equal to or above 4.2 v.s. Li/Li⁺.

### CROSS REFERENCE TO RELATED APPLICATIONS

This application is a 371 U.S. Application claiming priority to PCT/US2021/027585, filed Apr. 16, 2021, which claims priority to U.S. Provisional Pat. Application Serial Nos. 63/011,317, filed Apr. 17, 2020, and U.S. Provisional Pat. Application No. 63/043,797, filed Jun. 25, 2020, which is hereby fully incorporated by reference herein.

### FIELD

This application is directed to improved porous membranes, and to battery separators and liquid electrolyte secondary lithium ion batteries comprising the same. Particularly, the improved porous membranes disclosed herein may be used to form thinner and safer battery separators and batteries.

### BACKGROUND

The electric vehicles (EVs or HEVs for example) industrial market focuses strongly on increasing the energy density of lithium secondary batteries while maintaining safety and lifetime.

One development towards improving safety is the shutdown separator. For example, trilayer shutdown separators are described in U.S. Pat. No. 5,952,120, which is incorporated herein by reference in its entirety. These shutdown separators typically have a structure PP/PE/PP, PP/PE/PE/PP, PP/PE/PE/PE/PP, etc., where all layers are the same or substantially the same thickness. This symmetry was preferred, for example, because asymmetry in the separator could result in curling or other issues. Generally, shutdown separators improve safety at high temperatures by stopping ion transport across the separator and current flow. The lower melt temperature PE layers melt before the PP layers, and the melted PE fills the pores of the separators, blocking ion transport.

It is generally accepted that thinner separators allow for the formation of higher energy density batteries- more cells can be included in a single battery having approximately the same weight and thickness. Thus, it would appear that a promising way to achieve high energy density, but not sacrifice safety, is to make thin and ultra-thin shutdown separators, e.g., tri-layer shutdown products, by decreasing the overall weight and overall thickness of tri-layers. However, the simple decrease of overall thickness symmetrically to make the ultra-thin or thin shutdown separators, e.g., tri-layer shutdown separators, still have application issues. For example, the rough surface of cathode surface would easily break and penetrate the outer layer of PP when used in the liquid electrolyte Li secondary batteries. Additionally, the electrons at high voltage would easily oxidize PE layers which can initiate side reactions and produce gases. In this case, the energy density and safety are decreased. Thus, it is desirable to increase the oxidization resistance of inner PE layers in the thin and ultra-thin shutdown separators, e.g., tri-layer shutdown separators or other shutdown structures.

### SUMMARY

In one aspect, a porous membrane comprising two outer layers and at least one inner layer is described herein. The ratio of the thickness of one of the two outer layers to the other of the two outer layers may, in some preferred embodiments, be from 1.1:1 to 4:1, from 1.1: 1 to 3:1, or from 1.1: 1 to 3:1. The total thickness of the membrane may be from 5 to 30 microns, from 5 to 20, from 5 to 15 microns, or from 5 to 10 microns.

In some embodiments, the porous membrane may be a microporous membrane. In some embodiments, the porous membrane may be a dry process microporous membrane or a microporous membrane made by a dry stretch process.

In some embodiments, the porous membrane may comprise between 1 and 10 inner layers. In some embodiments, the porous membrane may comprise only one inner layer, making the porous membrane a trilayer.

In some embodiments, the two outer layers may comprise, consist of, or consist essentially of polypropylene. At least one of the inner layers may comprise, consist of, or consist essentially of polyethylene. In some embodiments, the porous membrane may have a trilayer structure-PP/PE/PP, where “PP” is a polypropylene containing layer and “PE” is a polyethylene-containing layer.

In some embodiments, the porous membrane may be formed by a method comprising laminating at least one outer layer with at least one inner layer. In some embodiments, the porous membrane may be formed by a method comprising coextruding at least one outer layer with at least one inner layer.

In another aspect, a porous membrane comprising two outer layers, wherein one layer is thicker than the other, is described herein. The ratio of the thicknesses may be from 1: 1.1 to 4:1. The total thickness of the membrane may be from 5 to 30 microns, from 5 to 20, from 5 to 15 microns, or from 5 to 10 microns. In some preferred embodiments, the total thickness of the membrane may be 8 to 12 microns. In some preferred embodiments, calendering may be performed to achieve a thin or thinner separator having a thickness of, for example, 5 to 12 microns. In some embodiments, calendering is not necessary to form a thin or thinner separator. Calendering may also reduce the pore sizes.

In some embodiments, the porous membrane may be a microporous membrane. In some embodiments, the porous membrane may be a dry process microporous membrane or a microporous membrane made by a dry stretch process.

In some preferred embodiments, the thicker layer may comprise, consist of, or consist essentially of polypropylene, and the thinner layer may comprise, consist of, or consist essentially of polyethylene.

In some embodiments, the porous membrane may be formed by a method including a step of coextruding the two layers-the thinner layer and the thicker layer. In some embodiments, the porous membrane may be formed by a method comprising a step of laminating one of the two layers to the other of the two layers. Preferably, the battery separator has an electrochemical stability voltage greater than or equal to above 4.2 v.s. Li/Li⁺, equal to or above 4.5 v.s. Li/Li⁺, or equal to or above 5.0 v.s. Li/Li⁺. Typically, these results come from a cyclic voltammetry method. In a typical procedure, two blocking electrodes are used; Pt is used as the cathode and Li metal on the anode. The separator is placed between the electrodes in a sandwich structure with the electrolyte in between. A scan occurs using voltages from zero to 5 Volts. Current changes in response to voltage. Side reactions can be seen as peaks in Current-Voltage plots.

In some embodiments, the separator comprises any one of the porous membranes described herein with a coating on the thinner outer layer or on the thinner of the two layers. In some embodiments, the coating is selected from at least one of a ceramic coating, a polymer coating, a shutdown coating, a cross-linked coating, or a combination thereof. In some embodiments, the coating has a thickness from 1 to 5 microns.

In another aspect, a secondary battery is disclosed, which comprises, consists of, or consists essentially of an anode, a cathode, liquid electrolyte, and any battery separator described herein between the anode and the cathode. In preferred embodiments, the thicker of the two outer layers of the porous membrane faces the cathode. The thinner coated or uncoated outer layer faces the anode.

In another aspect, a porous membrane comprising two outer layers and at least one inner layer is described. One of the outer layers has a smaller average pore size, lower porosity, and/or higher tortuosity than the other outer layer.

In another aspect, described is a battery separator comprising, consisting of, or consisting essentially of the porous membrane with outer layers having different average pore sizes is also described. In some embodiments, the separator has an electrochemical stability voltage equal to or above 4.2 v.s. Li/Li⁺. In some embodiments, the electrochemical stability voltage is equal to or above 4.5 v.s. Li/Li⁺ or equal to or above 5.0 v.s. Li/Li⁺.

In some embodiments, the battery separator has a coating applied to the outer layer having the smaller average pore size, lower porosity, and/or higher tortuosity. The coating may be at least one of the following: a ceramic coating, a polymer coating, and a shutdown coating. The coating layer may have a thickness from 1 to 5 microns.

In another aspect, a secondary battery is described. The secondary battery may comprise an anode, a cathode, liquid electrolyte, and the battery separator comprising the porous membrane with outer layers having different average pore sizes as described herein between the anode and the cathode. In some embodiments, the outer layer having the smaller average pore size, lower porosity, and/or higher tortuosity may face the anode. In embodiments where the battery separator has a coating applied to the outer layer of the porous membrane having the smaller average pore size, the lower porosity, and/or the higher tortuosity, the coating may face the anode.

In yet another aspect, an asymmetric porous multilayer membrane comprising at least one polypropylene (PP)-containing layer and at least one polyethylene (PE)-containing layer is described. A thickness ratio of the PP-containing layer or layers to the PE-containing layer or layers is in the range of 1.1: 1 to 25:1, in the range of 1.1: 1 to 20:1, or in the range of 4:1 to 10:1.

In a possibly preferred embodiment, the membrane may comprise, consist of, or consist essentially of two PP-containing layers and one PE-containing layer, wherein the layers are arranged in the following order PE/PP/PP. In some embodiments, the membrane may comprise, consist of, or consist essentially of any one of the following structures: 73. PE/PE/PP/PP/PP/PP, wherein PE is a PE-containing layer and PP is a PP-containing layer; PE/PE/PE/PP/PP/PP/PP/PP/PP, wherein PE is a PE-containing layer and PP is a PP-containing layer; PE/PE/PE/PE/PP/PP/PP/PP/PP/PP/PP/PP, wherein PE is a PE-containing layer and PP is a PP-containing layer; or PE/PE/PE/PE/PE/PP/PP/PP/PP/PP/PP/PP/PP/PP/PP, wherein PE is a PE-containing layer and PP is a PP-containing layer.

In embodiments comprising two or more PP-containing layers, the layers may comprise, consist of, or consist essentially of the same or different PP-containing material. The PP-containing material may comprise, consist of, or consist essentially of at a single polypropylene, a mixture of two or more different polypropylenes, a single polypropylene and an additional component, or a mixture of two or more different polypropylenes and an additional component. In some embodiments, the additional component may be an elastomer. The elastomer may be a styrenic elastomer.

In embodiments comprising two or more PE-containing layers are present, the PE-containing layers may comprise, consist of, or consist essentially of the same or different PE-containing material.

In possibly preferred embodiments, the multilayer membranes are formed by co-extruding two or more or three or more of the layers, but the membranes may also be formed by laminating the layers or a combination of coextrusion and lamination. For example, all three layers of the PE/PP/PP structure may be coextruded. Alternatively, they may all be laminated. For lamination, the laminated layers may be a combination of layers formed by different processes, e.g., wet, dry, etc., or a combination of layers formed by the same process. For example a wet PE layer may be laminated to two PP layers formed by a dry-process.

In some preferred embodiments, the multilayer membrane may be a dry-process multilayer membrane. The membrane may also be formed by a wet process, a beta-nucleating process, or the like.

In another aspect, a battery separator that comprises, consists of, or consists essentially of the asymmetric porous multilayer membrane described above is described. In some embodiments, the battery separator comprises a membrane where only one of the outermost layers of the asymmetric porous multilayer membrane is a PE-containing layer. In some embodiments, the battery separator may comprise a coating on either side of the asymmetric porous multilayer membrane described herein. The coating may be any one of a ceramic coating, a shutdown coating, a sticky coating, a polymer coating, or combinations thereof.

In another aspect, a battery comprising the battery separator herein is described. The battery may comprise, consist of, or consist essentially of an anode, a cathode, a liquid electrolyte, and the asymmetric multilayer porous membrane. In some embodiments, an outermost PE-containing layer of the separator may face the anode.

In yet another aspect, an asymmetric porous multilayer membrane comprising at least one polypropylene (PP)-containing layer and at least one polyethylene (PE)-containing layer is described. A thickness ratio of the PE-containing layer or layers to the PP-containing layer or layers is in the range of 1.1:1 to 25:1, in the range of 1.1: 1 to 20:1, or in the range of 4:1 to 10:1. The particulars of such membrane may otherwise be like the membrane described above where the amount of PP is larger and PP-containing layers in that membrane become PE-containing layers and PE-containing layers become PP-containing layers.

### DESCRIPTION OF THE DRAWINGS

FIG. 1 is a schematic drawing of exemplary membranes described herein.

FIG. 2A and FIG. 2B are both FESM images of exemplary membranes described herein.

FIG. 3 is a schematic drawing showing the difference between membrane thickness and pore length. Tortuosity is derived from these two measurements.

FIG. 4A, FIG. 4B, FIG. 4C, FIG. 4D, FIG. 4E, and FIG. 4F are schematic drawings of exemplary embodiments described herein.

FIG. 5A and FIG. 5B are schematic drawings of exemplary embodiments described herein.

FIG. 6A, FIG. 6B, and FIG. 6C are schematic drawings of exemplary embodiments described herein.

FIG. 7 shows pore size distribution for exemplary embodiments described herein.

### DETAILED DESCRIPTION

### Asymmetric Porous Membrane

An asymmetric porous membrane is described herein. The asymmetric porous membrane may comprise, consist of, or consist essentially of two outer layers and optionally at least one inner layer. There may be 0, 1, 2, 3, 4, 5, 6, 7, 8, 9, 10, or more inner layers. In some embodiments, the porous membrane may consist of or consist essentially of two outer layers and no inner layers. The ratio of the thickness of one of the two outer layers to the other of the two outer layers may be from 1.1: 1 to 10:1, from 1.1: 1 to 9:1, from 1.1: 1 to 8:1, from 1.1: 1 to 7:1, from 1.1:1 to 6:1, from 1.1:1 to 5:1, from 1.1:1 to 4:1, from 1.1:1 to 3:1, or from 1.1:1 to 2:1. In some preferred embodiments, the total thickness of the porous membrane may be from 2 to 30 microns, from 2 to 25 microns, from 2 to 20 microns, from 2 to 15 microns, or from 2 to 10 microns. In some embodiments, the total thickness of the porous membrane may be from 3 to 12 microns, from 4 to 12 microns, from 5 to 12 microns, or from 9 to 12 microns. In some embodiments, at least one of the outer layers has a thickness from 2 to 6 microns or 4 to 5 microns. In some embodiments, the outer layer having a thickness of from 2 to 6 microns or from 4 to 5 microns is placed facing the cathode when the asymmetric porous membrane is used in a battery.

In some embodiments, the outer layers may have different average pore sizes, different porosities, and/or different tortuosities with one of the outer layer having a larger average pore size, higher porosity, and/or higher tortuosity and the other having a smaller average pore size, lower porosity, and/or lower tortuosity. In some embodiments, both pore size, porosity and/or tortuosity as well as the thickness of the two outer layers may be different. In some embodiments, only thickness or only pore size, porosity, and/or tortuosity of the outer layers may be differrent.

In some embodiments, the asymmetric porous membrane may be macroporous, nanoporous, or microporous. In some preferred embodiments, the asymmetric porous membrane may be a microporous membrane. For example, the pores of the porous membrane may have an average pore size from 0.01 to 1.0 microns. In some preferred embodiments, the average pore size may be from 0.1 to 1.0 microns, from 0.1 to 0.9 microns, from 0.1 to 0.8 microns, from 0.1 to 0.7 microns, from 0.1 to 0.6 microns, from 0.1 to 0.5 microns, from 0.1 to 0.4 microns, from 0.1 to 0.3 microns, or from 0.1 to 0.2 microns. The pores of the porous membrane may have any shape. For example, they may be slit-shaped, round, substantially round, or asymmetric.

In some preferred embodiments, the asymmetric porous membrane may be a dry process asymmetric porous membrane. A dry-process, in some embodiments, is a process that does not use any pore-forming agent/pore-former, or beta-nucleating agent/beta-nucleator. In some embodiments, a dry-process is one that does not use any solvent, wax, or oil. In some embodiments, a dry-process is one that does not use any pore-forming agent/pore former, or beta-nucleating agent/beta-nucleator, and also does not use any solvent, wax, or oil.

The dry process asymmetric porous membrane may be formed by a dry-stretch process. An exemplary dry-stretch process known as the Celgard® dry stretch process is described in Chen et al., Structural Characterization of Celgard® Microporous Membrane Precursors:Melt-Extruded Polyethylene Films, J. of Applied Polymer Sci., vol. 53, 471-483 (1994), which is incorporated by reference herein in its entirety. The Celgard® dry stretch process refers to a process where pore formation results from stretching a nonporous oriented precursor at least in the machine direction. Kesting, Robert E., Synthetic Polymeric Membranes, A Structural Perspective, Second Edition, John Wiley & Sons, New York, N.Y., (1985), pages 290-297, also discloses a dry-stretch process and is incorporated herein by reference in its entirety. In a dry-stretch process according to some preferred embodiments, the process may comprise a stretching step. The stretching step may comprise, consist of, or consist essentially of uniaxial stretching (e.g., stretching in only the MD direction or in only the TD direction), biaxial stretching (e.g., stretching in the MD and TD direction), or multi-axial stretching (e.g., stretching along three or more different axes such as MD, TD, and another axis). In some embodiments, the dry-stretch process may comprise, consist of, or consist essentially of an extrusion step and a stretching step, in that order or not in that order. In some embodiments, the dry stretch process may comprise, consist of, or consist essentially of an extrusion step, an annealing step, and a stretching step, in that order or not in that order. The extrusion step, in some embodiments, may be a blown-film extrusion step or a cast-film extrusion process. In some embodiments, a non-porous precursor is extruded and stretched to form pores. In some embodiments, a non-porous precursor is extruded, annealed, and then stretched to form pores. In other embodiments, a porous or non-porous precursor may be formed by a method other than extrusion, such as by sintering or printing, and stretching may be performed on the precursor to form pores or to make existing pores larger.

In some embodiments, pore-forming agent/pore former, or beta-nucleating agent/beta-nucleator may be used and the process is still considered a dry-process. For example, a particle stretch process may be considered to be a dry process because oil or solvent is not extruded with the polymer and extracted from the extruded polymer to form pores. In a particle stretch process, particles such as silica or calcium carbonate are added to a polymer mixture, and these particles help to form the pores. In such a method, for example, the polymer mixture comprising particles and a polymer is extruded to form a precursor that is stretched and voids are created around the particles. In some embodiments, the particles may be removed after the voids are created. While a particle stretch process may include a stretching step before or after the removal of the particles, a particle stretch process is not considered a dry-stretch process because the principle pore formation mechanism is the use of the particles not stretching.

In some preferred embodiments, the structure of a dry-process porous membrane may have one or more distinguishing features. For example, a dry-process membrane may comprise an amount of polypropylene greater than 10%. Wet-processes or other processes using a solvent are not generally compatible with polypropylene because the solvents degrade polypropylene. Thus, wet process porous membranes typically contain no more than 10% polypropylene, and most typically 5% or less. One other distinguishing feature of some dry process porous membranes, particularly those used as battery separators, is the ability to have a shutdown function. Shutdown function may be imparted, in some cases, by a PP/PE/PP structure, where the PE-layer is a shutdown layer. This is unique to dry-process membranes because layers comprising mainly polypropylene (PP) generally cannot be formed in a wet process. A dry process is uniquely suited to form a PP/PE/PP or other shutdown membrane structures.

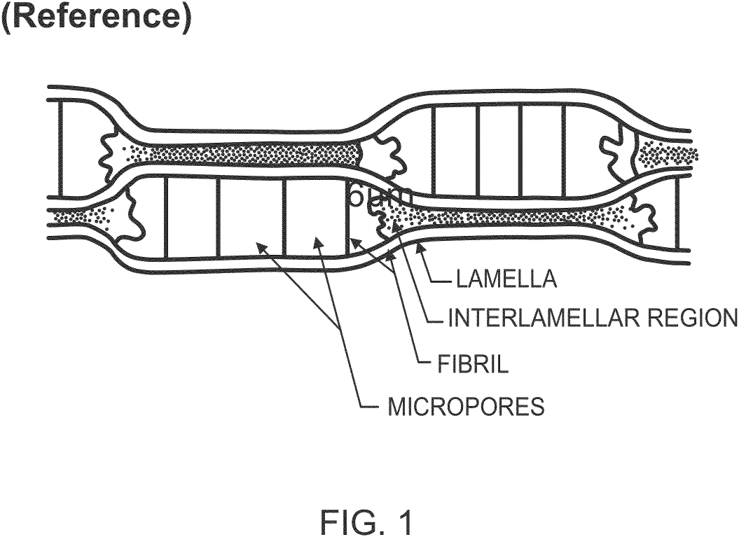

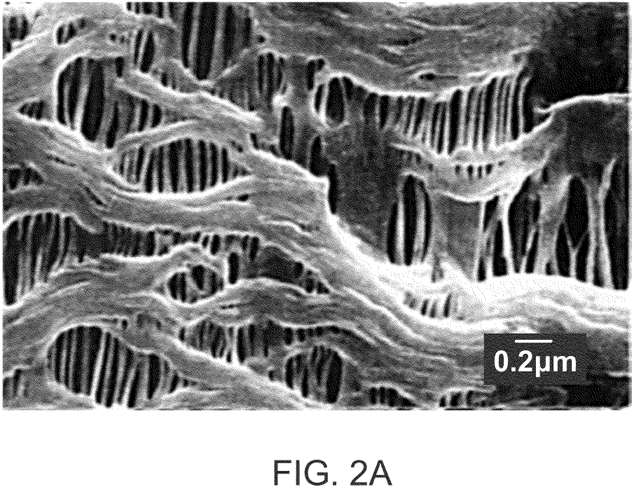

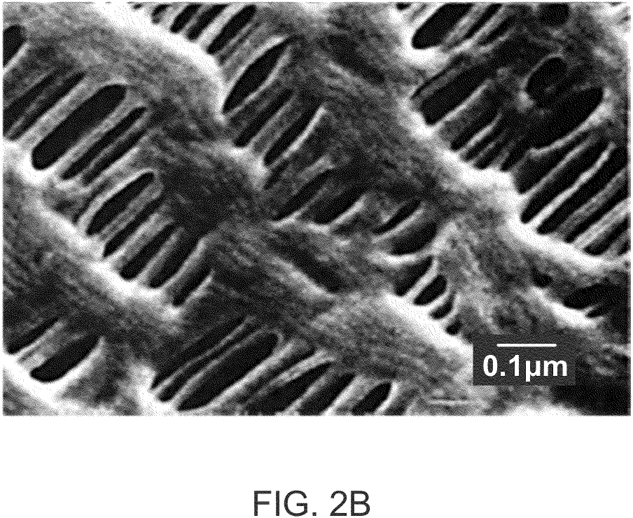

In some embodiments, a distinguishing dry-process porous membrane may be the presence of lamellae and fibrils. For example, the porous membrane may have a structure like that shown in FIG. 1 of FIGS. 2A and 2B. FIGS. 2A and 2B are FESM images showing slit-like micropores in Celgard® microporous membranes comprising PE (A) and PP(B). In some embodiments, the pores or micropores of a dry-process porous membrane may be round, oblong, semi-round, trapezoidal, etc.

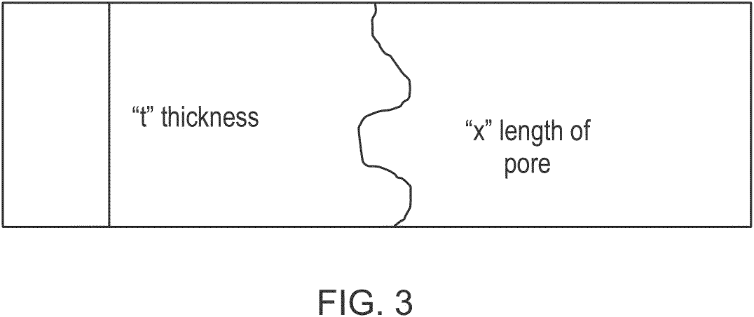

In some embodiments, a distinguishing feature of a dry-process porous membrane is that it contains no or substantially no pin-holes. Pin-holes are considered a defect, and generally are not an intentionally formed feature of a dry-process porous membrane. In some embodiments, the dry-process microporous membrane may contain no or substantially no pin-holes greater than 10 nm. In some preferred embodiments, the pores of a dry-process porous membrane are tortuous. In some embodiments, a distinguishing feature of a dry-process porous membrane is tortuosity. In some embodiments, the tortuosity of a dry-process porous membrane is greater than 1, greater than 1.2, greater than 1.3, greater than 1.4, greater than 1.5, greater than 1.6, greater than 1.7, greater than 1.8, greater than 1.9, or greater than 2.0. In some embodiments, a formula for calculating tortuosity crudely is formula (1):

$$\text{Tortuosity=x/t}$$

where “x” is the length of the opening or pore in a porous membrane and “t” is the thickness of the membrane. A pin-hole has a tortuosity of 1 because the length of the pin hole is the same as the thickness of the membrane. A tortuous pore has a tortuosity greater than 1 as shown in FIG. 3 because the length of the pore is longer than the thickness of the membrane.

In some embodiments, the dry-stretch porous membrane is semi-crystalline. In some embodiments, the dry-stretch porous membrane is semi-crystalline and oriented in a single direction. For example, the membrane may be MD-oriented. A porous film formed by a wet process, such as a film formed by a beta-nucleation process, may be randomly oriented.

In some embodiments, the asymmetric porous membrane may be formed by laminating at least one outer layer with at least one inner layer. In embodiments where no inner layers are included, the asymmetric porous membrane may be formed by laminating at least one outer layer with the other outer layer. For example, if the asymmetric porous membrane is formed by a dry process, such as a dry stretch process, the membrane may be formed by separately extruding at least one of the outer layers and one of the inner layers or separately extruding both of the outer layers. Then, one of the outer layers may be laminated with the other outer layer or one of the inner layers before or after a stretching step is performed.

In some embodiments, the asymmetric porous membrane may be formed by coextruding at least one of the outer layers with at least one of the inner layers. In embodiments where there are no inner layers, the asymmetric porous membrane may be formed by coextruding the two outer layers. For example, if the asymmetric membrane is formed by a dry process such as a dry stretch process, the two outer layers may be coextruded together and the coextrudate, which is nonporous, may be stretched to form pores. In another example, if a dry process, such as a dry stretch process is used to form the asymmetric porous membrane, at least one of the outer layers is coextruded with at least one of the inner layers, and then the coextrudate, which is nonporous, may be laminated with an inner layer or the other outer layer. Lamination may occur before or after stretching which may be used to form pores.

In some embodiments, the outer layers of the asymmetric membrane may comprise, consist of, or consist essentially of polyethylene. In some embodiments, at least one of the inner layers may comprise, consist of, or consist essentially of polyethylene. For example, in some embodiments, the asymmetric membrane may be membrane with the following structure PP/PE, PP/PE/PP or PP/PE/PE/PP, or PP/PE/PE/PE/PP, or PP/PE/PE/PE/PE/PP, or PP/PE/PE/PE/PE/PE/PP, or PP/PE/PE/PE/PE/PE/PE/PP, or PP/PE/PE/PE/PE/PE/PE/PE/PP, or PP/PE/PE/PE/PE/PE/PE/PE/PP, or PP/PE/PE/PE/PE/PE/PE/PE/PE/PP, or PP/PE/PE/PE/PE/PE/PE/PE/PE/PE/PP, or PP/PE/PE/PE/PE/PE/PE/PE/PE/PE/PE/PP, or PE/PP/PP, or PE/PE/PP/PP/PP/PP, or PE/PE/PE/PP/PP/PP/PP/PP, or PE/PE/PE/PE/PP/PP/PP/PP/PP/PP/PP/PP, or PE/PE/PE/PE/PE/PP/PP/PP/PP/PP/PP/PP/PP/PP/PP, or PE/PP/PP/PP, or PE/PP/PP/PP/PP, or PE/PP/PP/PP/PP/PP, or PE/PP/PP/PP/PP/PP/PP, or PE/PE/PP/PP/PP. In embodiments where the asymmetric membrane comprises two outer layers and no inner layer, at least one of the outer layers may comprise, consist of, or consist essentially of polypropylene, and the other may comprise, consist of, or consist essentially of polyethylene. In preferred embodiments, the thicker of the two outer layers may comprise, consist of, or consist essentially of polypropylene. In preferred embodiments, the thinner of the two outer layers, when no inner layer is provided, may comprise, consist of, or consist essentially of polyethylene.

In some embodiments, the asymmetric multilayer porous membrane may comprise at least one polypropylene (PP)-containing layer and at least one polyethylene (PE)-containing layer, wherein a thickness ratio of the PP-containing layer or layers to the PE-containing layer or layers is from 1.1:1 to 25:1, from 1.1:1 to 20:1, from 1.1:1 to 15 to 1, from 1.1:1 to 10:1, from 1.1:1 to 9:1, from 1.1:1 to 8:1, from 1.1:1 to 7:1, from 1.1:1 to 6:1, from 1.1:1 to 5:1, from 1.1:1 to 4:1, from 1.1: 1 to 3:1, or from 1.1: 1 to 2:1. For example, a structure PE/PP/PP may have a 1 micron thick PE-containing layer (PE) and two 3.5 micron thick PP-containing layers (PP), giving a ratio of 7:1.

In a possibly preferred embodiment, the membrane may comprise, consist of, or consist essentially of two PP-containing layers and one PE-containing layer, wherein the layers are arranged in the following order PE/PP/PP. In some embodiments, the membrane may comprise, consist of, or consist essentially of any one of the following structures: PE/PE/PP/PP/PP/PP, wherein PE is a PE-containing layer and PP is a PP-containing layer; PE/PE/PE/PP/PP/PP/PP/PP/PP, wherein PE is a PE-containing layer and PP is a PP-containing layer; PE/PE/PE/PE/PP/PP/PP/PP/PP/PP/PP/PP, wherein PE is a PE-containing layer and PP is a PP-containing layer; or PE/PE/PE/PE/PE/PP/PP/PP/PP/PP/PP/PP/PP/PP/PP, wherein PE is a PE-containing layer and PP is a PP-containing layer. The structure may also be PE/PP/PP/PP, PE/PP/PP/PP/PP, PE/PP/PP/PP/PP/PP, and the like.

In membranes comprising two or more, three or more, four or more, five or more, six or more, seven or more, eight or more, nine or more, ten or more, or up to 100 PP-containing layers, each of the PP-containing layers may comprise, consist of, or consist essentially of the same or different PP-containing material. PP-containing materials may comprise, consist of, or consist essentially of at least 50% polypropylene. Some may contain at least 55% PP, at least 60% PP, at least 65% PP, at least 70% PP, at least 75% PP, at least 80% PP, at least 85% PP, at least 90% PP, at least 95% PP, or 100% PP. Polypropylene may comprise, consist of, or consist essentially of a single PP homopolymer, copolymer, or terpolymer or a blend of two or more different homopolymers, copolymers, terpolymers, or combinations thereof. In some embodiments, the PP-containing material may comprise, consist of, or consist essentially of a PP homopolymer, copolymer, or terpolymer, or a blend of two or more PP homopolymers, copolymers, or terpolymers and an additional component. The additional component may be any one of an additional polymer, an elastomer, and the like or combinations thereof. The elastomer may be added, for example, to improve strength. For example, the elastomer may be a styrenic elastomer.

In some embodiments where the membrane comprise two or more PE-containing layers the PE-containing layers may include the same or different PE-containing materials. PE-containing materials may comprise, consist of, or consist essentially of at least 50% polyethylene. Some may contain at least 55% PE, at least 60% PE, at least 65% PE, at least 70% PE, at least 75% PE, at least 80% PE, at least 85% PE, at least 90% PE, at least 95% PE, or 100% PE. Polyethylene may comprise, consist of, or consist essentially of a single PE homopolymer, copolymer, or terpolymer or a blend of two or more different homopolymers, copolymers, terpolymers, or combinations thereof. In some embodiments, the PE-containing material may comprise, consist of, or consist essentially of a PE homopolymer, copolymer, or terpolymer, or a blend of two or more PE homopolymers, copolymers, or terpolymers and an additional component. The additional component may be any one of an additional polymer, an elastomer, and the like or combinations thereof. The elastomer may be added, for example, to improve strength. For example, the elastomer may be a styrenic elastomer.

In some embodiments, two or more or three or more of the layers may be co-extruded. For example, for a PE/PP/PP structure all three layers may be co-extruded or two may be co-extruded and the third layer may be laminated to the two co-extruded layers. As another example, in a PE/PE/PE/PP/PP/PP/PP/PP/PP structure, the three PE layers may be coextruded-(PE/PE/PE) and the two sets of three PP layers may be separately coextruded- (PP/PP/PP). Then, the PE coextruded and the two sets of PP coextruded layers may be laminated together to form the final structure -(PE/PE/PE)/(PP/PP/PP)/(PP/PP/PP). A structure (PE/PE/PE/PE)/(PP/PP/PP/PP)/(PP/PP/PP/PP), (PE/PP/PP/PP)/(PP/PP/PP/PP)/(PP/PP/PP/PP), (PE/PE/PP/PP)/(PP/PP/PP/PP)/(PP/PP/PP/PP), (PE/PE/PE/PP)/(PP/PP/PP/PP)/(PP/PP/PP/PP), and the like may be formed. (PP/PP/PP/PP), (PE/PE/PP/PP), etc. represent co-extruded structures and “/” denotes a lamination interface. In some embodiments, all the layers may be laminated together. For example, for the PE/PP/PP structure, a PE layer and two other PP layers may be laminated together. Coextrusion of the layers may be preferred to lamination due to the ability to form thinner layers without the film handling issues that occur when laminating thin films less than 10 microns, especially less than 5 microns, or particularl less than 1 micron.

In some preferred embodiments, the multilayer asymmetric porous membrane may be a dry-process membrane as described herein above.

In some embodiments, the asymmetric porous membrane may be macroporous, nanoporous, or microporous. In some preferred embodiments, the asymmetric porous membrane may be a microporous membrane. For example, the pores of the porous membrane may have an average pore size from 0.01 to 1.0 microns. In some preferred embodiments, the average pore size may be from 0.1 to 1.0 microns, from 0.1 to 0.9 microns, from 0.1 to 0.8 microns, from 0.1 to 0.7 microns, from 0.1 to 0.6 microns, from 0.1 to 0.5 microns, from 0.1 to 0.4 microns, from 0.1 to 0.3 microns, or from 0.1 to 0.2 microns. The pores of the porous membrane may have any shape. For example, they may be slit-shaped, round, substantially round, or asymmetric.

### Battery Separator

The battery separator described herein is not so limited. In preferred embodiments, the battery separator may comprise, consist of, or consist essentially of at least one of the asymmetric porous membranes described herein. In some preferred embodiments, the asymmetric porous membrane may be a microporous asymmetric membranes.

Preferably, the battery separator has an electrochemical stability voltage greater than or equal to above 4.2 v.s. Li/Li⁺, equal to or above 4.5 v.s. Li/Li⁺, or equal to or above 5.0 v.s. Li/Li⁺.

In some embodiments, the separator is configured to provide superior resistance to oxidation compared to a typical bilayer, trilayer, or multilayer separator where all layers, including the outermost layers, have the same or substantially the same thickness. A typical trilayer separator- PP/PE/PP-where each layer has the same thickness, may be susceptible to oxidation of the PE layer from the side of the separator closest to the cathode. A typical bilayer separator-PP/PE, PP/PP/PE, and the like- may also be susceptible to oxidation of the PE layer from the side of the separator closest to the cathode. A typical multilayer separator, for example some described inUS2018/0323417, which is incorporated by reference herein in its entirety, may have a structure (PP/PP/PP)/(PE/PE/PE)/(PP/PP/PP) or (PP/PP)/(PE/PE)/(PP/PP) for examples where (PP/PP/PP) or (PP/PP) represent a co-extruded trilayer and bilayer respectively and (PE/PE/PE) and (PE/PE) represents a co-extruded trilayer and bilayer respectively. According to the invention described herein, by providing a thicker outer polypropylene layer (or, for example, a thicker co-extruded bilayer, trilayer, etc. when forming a multilayer embodiment) and by placing this layer closest to the cathode, the separator described herein has better oxidation resistance when compared to a typical trilayer, bilayer, or multilayer separator where all layers have the same or substantially the same thickness. In embodiments where one outermost layer is PE and one outermost layer is PP, the PP layer may face or be closest to the cathode to provide oxidation resistance. In embodiments where an inner layer is provided, the other outermost layer may be thinner because oxidation resistance is mainly needed on the one side facing the cathode and because thinner separators are preferred. In embodiments where there are no inner layers, the other outer layer may be a thin polyethylene layer. The polyethylene layer may be providing a shutdown function. In that case, the polyethylene layer should be thick enough to provide that function.

In some embodiments, the separator described herein may comprise, consist of, or consist essentially of at least one asymmetric porous membrane as described herein where the thinner of the two outer layers of the asymmetric porous membranes is configured to be placed closest to an anode of a secondary battery. In some embodiments, this may mean that the thinner of the outer two layers is coated. For example, the thinner of the outer two layers may be coated with a ceramic coating that comprises, consists of, or consists essentially of inorganic or organic heat resistant or ceramic particles and a binder. For example, a ceramic coating may be one as described inUS 6,432,586, which is incorporated herein by reference in its entirety. A ceramic coating, among other things, helps prevent, deter, or slow the growth of lithium dendrites, which typically grow from the anode and towards the cathode of a typical secondary battery such as a lithium-ion battery. In some embodiments, the thinner of the two outer layers may be coated with a polymer coating or a shutdown coating. In some embodiments, the thicker of the two outer layers may also be coated.

### Battery

The battery described herein is a liquid electrolyte battery or cell or electrochemical device such as a capacitor or super capacitor. In some embodiments, the battery may comprise a battery separator as described herein between an anode and a cathode. In preferred embodiments, the battery separator comprises at least one of the asymmetric porous membranes described herein, and the thicker of the outermost layers of the porous membrane faces towards the cathode. The thinner of the two outermost layers, in preferred embodiments, faces the anode. When the battery separators described herein are coated, the coating faces the anode to prevent lithium dendrite.

A suitable anode may have an energy capacity greater than or equal to 372 mAh/g, preferably ≧700 mAh/g, preferably ≧3860 mAh/g and preferably ≧4200 mAh/g. The anode be constructed from a lithium metal foil or a lithium alloy foil (e.g. lithium aluminum alloys), or graphite, graphene, carbon nanotube and silicon (Si) ,li. The anode is not made solely from intercalation compounds containing lithium or insertion compounds containing lithium.

A suitable cathode may be any cathode compatible with the anode and may include an intercalation compound, an insertion compound, or an electrochemically inactive binders. Suitable intercalation materials includes, for example, LiCoO₂, LiNiO₂,LiNi_{0.8}Co_{0.2}O₂, LiNi_{0.8}Co_{0.1}₅Al_{0.05}O₂, LiMn_{0.5}Ni_{0.5}O₂, LiMn_{1/3}Ni_{1/3}Co_{1/3}O₂, LiMn_{0.4}Ni_{0.4}CO_{0.2}O₂, LiFePO₄ LiMn₂O₄, Suitable polymers include, for example, sodium carboxylmethyl cellulose (CMC), styrene-butadiene rubber (SBR), poly(vinylidene fluoride) (PVDF), polyimide (PI) and acrylic ester, (polyacetylene, polypyrrole, polyaniline, and polythiopene).

The nominal voltage of the batteries described herein may be equal to or above 4.0 V/cell, equal to or above 4.2 V/cell, equal to or above 4.5 volts/cell, equal to above 5.0 volts per cell, or equal to or above 5.5 volts per cell.

Any battery separator described hereinabove may be incorporated to any vehicle, e.g., an e-vehicle, or device, e.g., a cell phone or laptop, that is completely or partially battery powered.

Various embodiments of the invention have been described in fulfillment of the various objects of the invention. It should be recognized that these embodiments are merely illustrative of the principles of the present invention. Numerous modifications and adaptations will be readily apparent to those skilled in the art without departing from the spirit and scope of this invention.

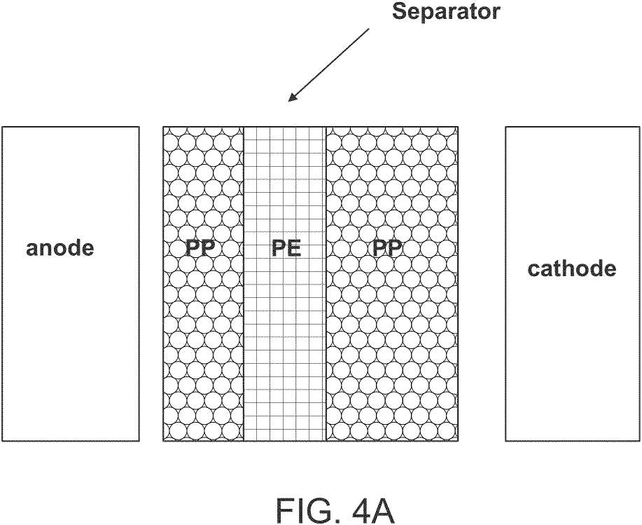

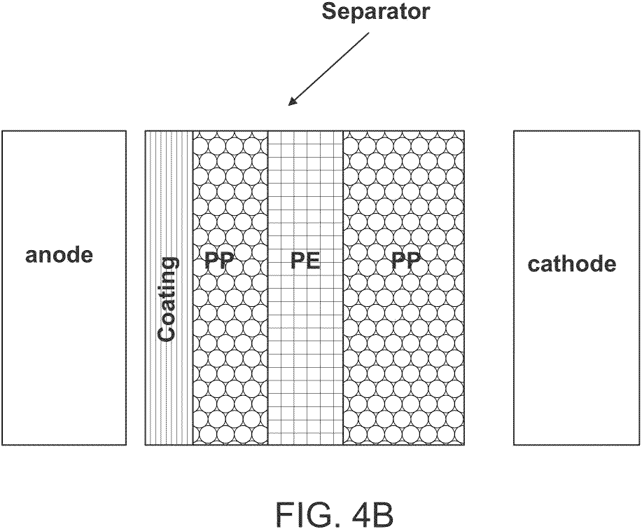

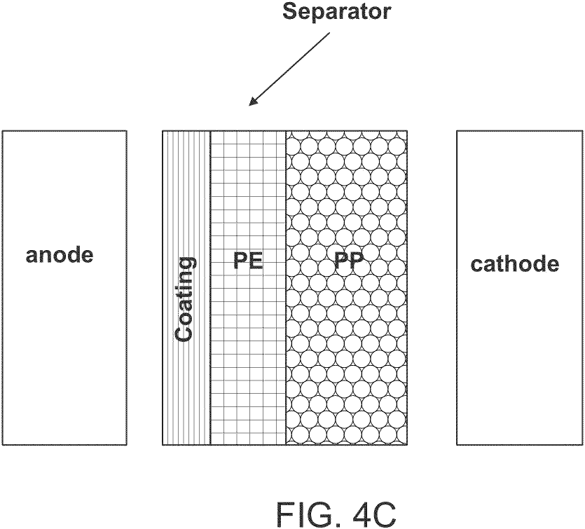

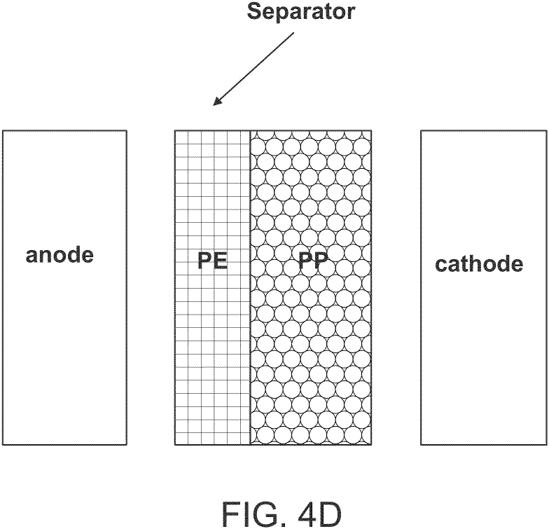

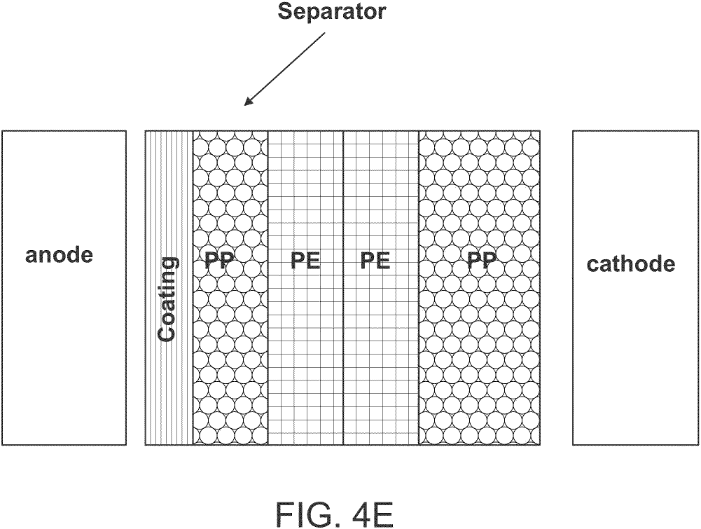

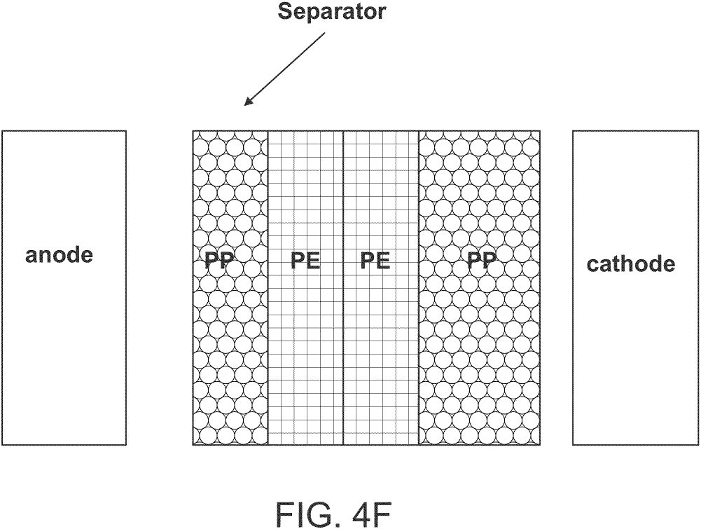

FIGS. 4A, 4B, 4C, 4D, 4E, and 4F schematically show some arrangements of a battery cell as disclosed herein.

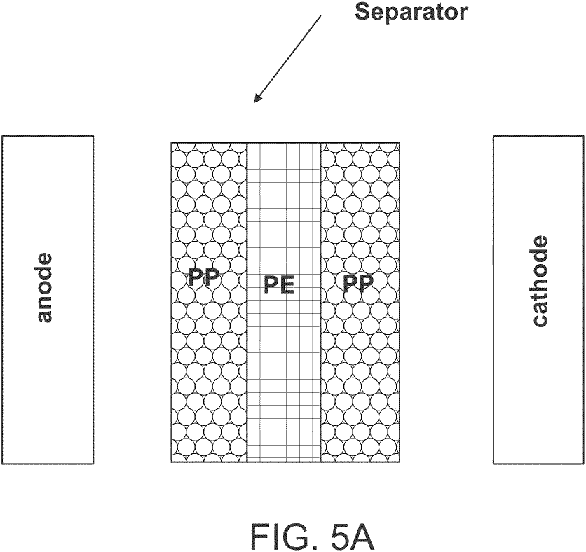

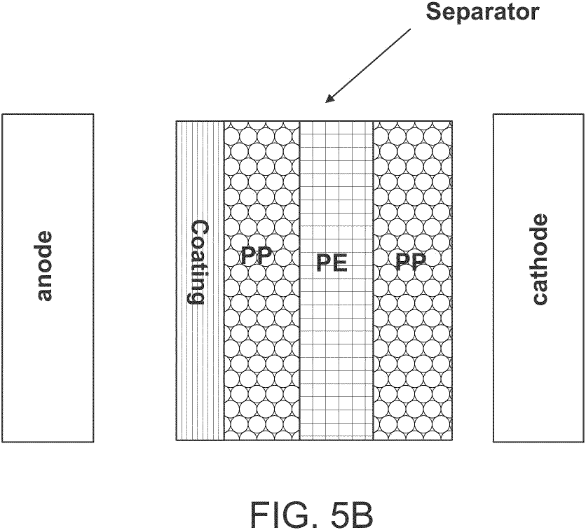

FIGS. 5A and 5B schematically show some arrangements of a battery cell according to other embodiments as disclosed herein. These Figures schematically show outer layers having different pore sizes, porosities, and/or tortuosities.

Some non-limiting examples are disclosed in the Table 1 below:

TABLE 1

| | | Structure and individual layer thicknesses(microns) | | | | |
|---|---|---|---|---|---|---|
| | Total thicknes s (microns ) | PP/PE/P P | PP/P E | PP/PE/PE/P P | PP/PE/PE/PE/P P | Multilayer* |
| Example 1 | 12 | 6/3/3 | | | | |
| Example 2 | 14 | 9/3/3 | | | | |
| Example 3 | 18 | 12/3/3 | | | | |
| Example 5 | 8 | 4/2/2 | | | | |
| Example 6 | 10 | 6/2/2 | | | | |
| Example 7 | 12 | 8/2/2 | | | | |
| Example 8 | 14 | 10/2/2 | | | | |
| Example 9 | 16 | 12/2/2 | | | | |
| Example 10 | 18 | 14/2/2 | | | | |
| Example 11 | 20 | 16/2/2 | | | | |
| Example 12 | 22 | 18/2/2 | | | | |
| Example 13 | 24 | 20/2/2 | | | | |
| Example 14 | 6 | | 3/3 | | | |
| Example 15 | 8 | | 4/4 | | | |
| Example 16 | 12 | | 6/6 | | | |
| Example 17 | 14 | | 7/7 | | | |
| Example 18 | 9 | | 6/3 | | | |
| Example 19 | 12 | | 9/3 | | | |
| Example 20 | 15 | | 12/3 | | | |
| Example 21 | 18 | | 15/3 | | | |
| Example 21 | 6 | | 4/2 | | | |
| Example 22 | 8 | | 6/2 | | | |
| Example 23 | 10 | | 8/2 | | | |
| Example 24 | 12 | | 10/2 | | | |
| Example 25 | 14 | | 12/2 | | | |
| Example 26 | 16 | | 14/2 | | | |
| Example 27 | 18 | | 16/2 | | | |
| Example 28 | 20 | | 18/2 | | | |
| Example 29 | 22 | | 20/2 | | | |
| Example 30 | 15 | | | 6/3/3/3 | | |
| Example 31 | 18 | | | 9/3/3/3 | | |
| Example 32 | 21 | | | 12/3/3/3 | | |
| Example 32 | 24 | | | 15/3/3/3 | | |
| Example 33 | 27 | | | 18/3/3/3 | | |
| Example 34 | 30 | | | 21/3/3/3 | | |
| Example 35 | 33 | | | 24/3/3/3 | | |
| Example 36 | 10 | | | 4/2/2/2 | | |
| Example 37 | 12 | | | 6/2/2/2 | | |
| Example 38 | 14 | | | 8/2/2/2 | | |
| Example 39 | 16 | | | 10/2/2/2 | | |
| Example 40 | 18 | | | 12/2/2/2 | | |
| Example 41 | 20 | | | 14/2/2/2 | | |
| Example 42 | 22 | | | 16/2/2/2 | | |
| Example 43 | 24 | | | 18/2/2/2 | | |
| Example 44 | 26 | | | 20/2/2/2 | | |
| Example 45 | 18 | | | | 6/3/3/3/3 | |
| Example 46 | 21 | | | | 9/3/3/3/3 | |
| Example 47 | 24 | | | | 12/3/3/3/3 | |
| Example 48 | 27 | | | | 15/3/3/3/3 | |
| Example 49 | 30 | | | | 18/3/3/3/3 | |
| Example 50 | 12 | | | | 4/2/2/2/2 | |
| Example 51 | 14 | | | | 6/2/2/2/2 | |
| Example 52 | 16 | | | | 8/2/2/2/2 | |
| Example 53 | 18 | | | | 10/2/2/2/2 | |
| Example 54 | 20 | | | | 12/2/2/2/2 | |
| Example 55 | 22 | | | | 14/2/2/2/2 | |
| Example 56 | 24 | | | | 16/2/2/2/2 | |
| Example 57 | 26 | | | | 18/2/2/2/2 | |
| Example 58 | 28 | | | | 20/2/2/2/2 | |
| Example 59 | 30 | | | | 22/2/2/2/2 | |
| Example 60 | 11 | 6/2/3 | | | | |
| Example 61 | 14 | 9/2/3 | | | | |
| Example 62 | 17 | 12/2/3 | | | | |
| Example 63 | 20 | 15/2/3 | | | | |
| Example 64 | 23 | 18/2/3 | | | | |
| Example 65 | 26 | 21/2/3 | | | | |
| Example 66 | 29 | 24/2/3 | | | | |
| Example 67 | 12 | | | | | (2/2/2)/(1/1/1)/(1/1/1) |
| Example 68 | 14 | | | | | (3/3/3)/(1/1/1)/(1/1/1) |
| Example 69 | 16 | | | | | (4/4/4)/(1/1/1)/(1/1/1) |
| Example 70 | 10 | | | | | (2/2/2)(0.66/0.66/0.66)/(0.66/0.66/0.66) |

*Multilayer embodiments were formed by laminating co-extruded PP and PE bilayers or trilayers together to form resulting 6- or 9-layer structures. Structures with 12, 15, 18, 21, etc. layers may also be formed.

Examples 1 to 70 were prepared with and without a ceramic coating on the thinner of the two outer layers of the membrane or on the side intended to face the anode for a total of 140 Examples. The ceramic could also be formed on the thicker of the two outer layers or on both outer layers.

Examples 1 to 70 were also prepared so that the thinner outer layer had smaller pore sizes, lower porosity and/or higher tortuosity than the thicker outer layer. In some embodiments, these may be formed by forming a PP layer having a smaller pore size, lower porosity, and/or higher tortuosity or forming PP layers where one has a smaller pore size, lower porosity, and/or higher tortuosity and one has a larger pore size, higher porosity, and/or lower tortuosity and laminating the PP layer or PP layers with a PE layer to form the structures in the Table above.

Examples 71 to 75 were prepared having the structures PP/PE/PP, PP/PE, PP/PE/PE/PP, PP/PE/PE/PE/PP, (PP/PP)/(PE/PE)/(PP/PP), and (PP/PP/PP)/(PE/PE/PE)/(PP/PP/PP) where the layers all had the same thickness, but one of the outer layers had smaller pore size, lower porosity, and/or higher tortuosity than the other. For example, for the PP/PE structure, the PP layer had a smaller average pore size, lower porosity, and/or higher tortuosity than the PE layer. Also, for example, in the multilayer embodiments formed by laminating the co-extruded (PP/PP) or (PP/PP/PP) with the co-extruded (PE/PE) or (PE/PE/PE), one of the outer most PP layers or one of the co-extruded PP bilayers or trilayers may have smaller average pore size, lower porosity, and/or higher tortuosity than the other outermost PP layer or co-extruded PP bilayer or trilayer. Thickness of the outer most PP layers or the co-extruded PP trilayers or bilayers may also be different in some embodiments.

Regarding the two layer membranes, it is found that the thicker polypropylene provides the oxidation resistance, and the polyethylene layer provides shutdown capability. It is not necessary to have a second polypropylene layer (but in some embodiments there may be one), so it is not provided and a thinner separator is able to be obtained. It is also found that providing smaller pore sizes, lower porosity, and/or higher tortuosity in the polypropylene layer may help block dendrites when the layer having smaller pore sizes, lower porosity, and/or higher tortuosity is positioned to face the anode in a battery. A coating provided on this layer having smaller pore sizes, lower porosity, and/or higher tortuosity may be even better at delaying or stopping lithium dendrite growth. Growth of lithium dendrites may cause battery shorts, so a battery where their growth can be delayed or prevented is safer.

Regarding the three, four, and five layer embodiments, the thicker polypropylene layer provides oxidation resistance on a side of the membrane that is placed closest to the cathode in a secondary battery cell. A thinner polypropylene layer may be used on the other side where oxidation resistance is not as critical, allowing for formation of a thinner separator. A ceramic coating may be provide on the thinner of the two outer layers, which is configured to be closest to the anode where oxidation resistance is not as much of an issue. The ceramic coating may help prevent, deter, or slow the growth of lithium dendrites that grow from the anode to the cathode and may cause shorts and/or thermal runaway. A polypropylene layer having smaller average pore size may also be used on the side where oxidation resistance is not as critical, allowing for formation of a thinner separator. A ceramic coating may be provide on the outer layer having a larger average pore size, which is configured to be closest to the anode where oxidation resistance is not as much of an issue. The ceramic coating may help prevent, deter, or slow the growth of lithium dendrites that grow from the anode to the cathode and may cause shorts and/or thermal runaway.

In other embodiments, asymmetric structures with thin PE-containing outer layer are formed. Typically, providing a PE-containing layer on the outside is not preferred because such a layer may be oxidized in the battery cell also adding a PE-containing layer may lower the heat resistance of a separator because PE melts at a lower temperature than PP. However, a PE-containing layer does exhibit improved/reduced pin removal force compared to a PP-containing layer. Reduced pin removal force is a desired property particularly if the membrane is used as a battery separator in a cylindrical-type cell. Applicants have provided a thin outer PE-containing layer to provide reduced pin removal force while maintaining the heat resistance of the battery separator. Only one of the outermost layers is a PE-containing layer and it is preferred that this layer face or be closes to the anode in a battery cell because if it faces the cathode it will be oxidized unless a coating, such as a ceramic coating, is provided on the PE-containing layer to protect it. Providing a ceramic coating on the PE-containing layer may defeat the purpose of providing the layer to reduce pin removal force on a surface. A thicker PE-containing layer may be provided if shutdown properties are desired. Examples comprising a PE-containing outer layer are Examples 76 to 114 in Table 2 below:

TABLE 2

| | PE/PP/P P (thicknes s of layers) | (PE/PE/PE)/(PP/PP/PP)/(PP/PP/ PP) (thickness of set of three co-extruded layers, e.g., (PE/PE/PE)) | (PE/PP/PP)/(PP/PP/PP)/(PP/PP/ PP) (thickness of set of three co-extruded layers, e.g., (PE/PP/PP)) |
|---|---|---|---|
| Example 76 | 1/2.5/2.5 | | |
| Example 77 | 1/3.5/3.5 | | |
| Example 78 | 1/5/5 | | |
| Example 79 | 1/7.5/7.5 | | |
| Example 80 | 1/8/8 | | |
| Example 81 | 2/4/4 | | |
| Example 82 | 3/6/6 | | |
| Example 83 | 4/8/8 | | |
| Example 84 | 5/10/10 | | |
| Example 85 | 2/5/5 | | |
| Example 86 | 4/10/10 | | |
| Example 87 | 2/10/10 | | |
| Example 88 | 1/10/10 | | |
| Example 89 | | (1)/(2.5)/(2.5) | |
| Example 90 | | (1)/(3.5)/(3.5) | |
| Example 91 | | (1)/(5)/(5) | |
| Example 92 | | (1)/(7.5)/(7.5) | |
| Example 93 | | (1)/(8)/(8) | |
| Example 94 | | (2)/(4)/(4) | |
| Example 95 | | (3)/(6)/(6) | |
| Example 96 | | (4)/(8)/(8) | |
| Example 97 | | (5)/(10)/(10) | |
| Example 98 | | (2)/(5)/(5) | |
| Example 99 | | (4)/(10)/(10) | |
| Example 100 | | (2)/(10)/(10) | |
| Example 101 | | (1)/(10)/(10) | |
| Example 102 | | | (1)/(2.5)/(2.5) |
| Example 103 | | | (1)/(3.5)/(3.5) |
| Example 104 | | | (1)/(5)/(5) |
| Example 105 | | | (1)/(7.5)/(7.5) |
| Example 106 | | | (1)/(8)/(8) |
| Example 107 | | | (2)/(4)/(4) |
| Example 108 | | | (3)/(6)/(6) |
| Example 109 | | | (4)/(8)/(8) |
| Example 110 | | | (5)/(10)/(10) |
| Example 111 | | | (2)/(5)/(5) |
| Example 112 | | | (4)/(10)/(10) |
| Example 113 | | | (2)/(10)/(10) |
| Example 114 | | | (1)/(10)/(10) |

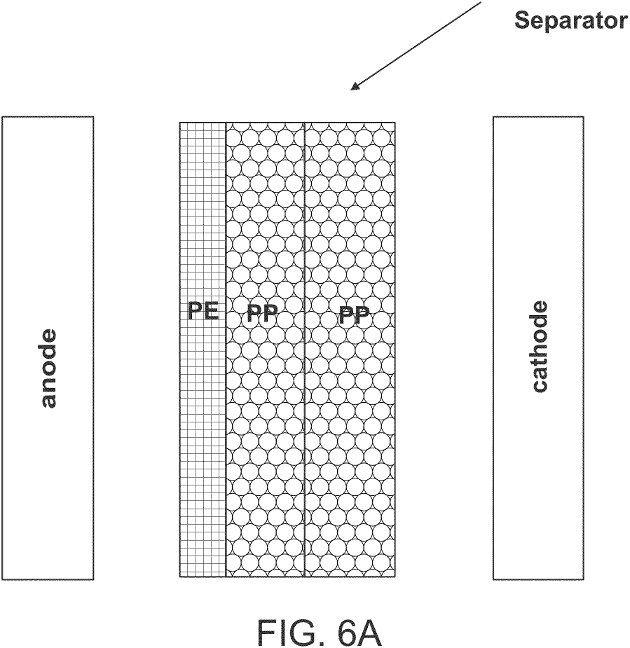

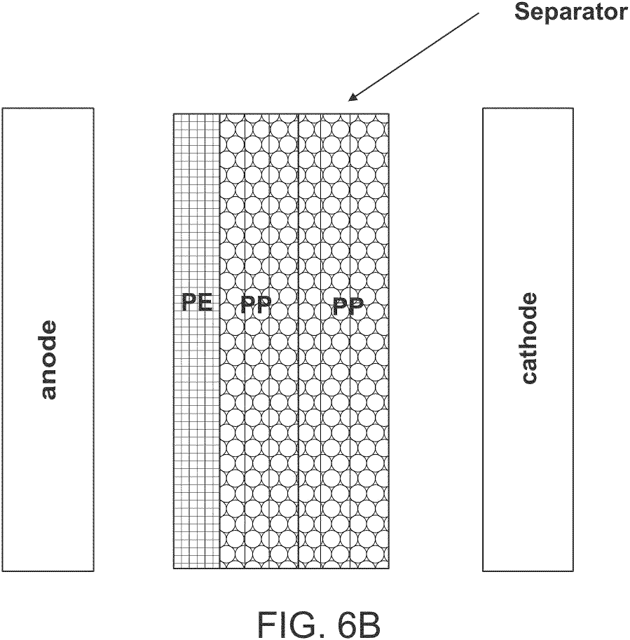

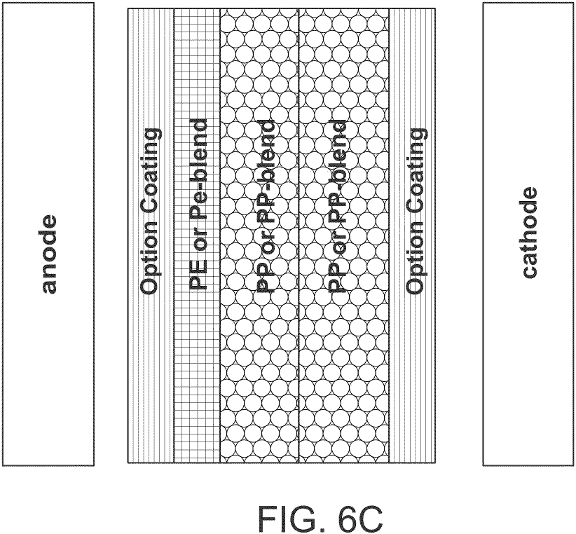

Examples 76-88 were formed by co-extruding the three layers, but could also have been formed by laminating them. Examples 89-101 were formed by co-extruding each of (PP/PP/PP) and (PE/PE/PE) and then laminating two (PP/PP/PP) composites with one (PE/PE/PE) composite to form the final structure. Examples 102-114 were formed by co-extruding each of (PE/PP/PP) and (PP/PP/PP) and laminating two (PP/PP/PP) composites with one (PE/PP/PP) to form the final structure. (PE/PP/PP) may also be replaced with (PE/PE/PP) to form a structure (PE/PE/PP)/(PP/PP/PP)/(PP/PP/PP). Stretching of the composites may be done before or after lamination. FIGS. 6A, 6B, and 6C show battery cells comprising membranes according to some embodiments as described herein above. In some preferred embodiments, a co-extruded structure PE/PP/PP as in any one of Examples 76-88 and the middle PP layer is formed from a polypropylene blend, which include polypropylene and at least one other polymer. For example, a styrenic elastomer may be used as the other polymer. The PE layer consists of polyethylene in these embodiments, and the outer PP layer consists of polypropylene in these embodiments. In any one of embodiments 76 to 114, a coating may be provided on one or both sides of the resulting structure. For example, a ceramic coating may be formed on a side facing the anode. In other embodiments, a cross-linked coating may be formed on either one of or both of a side facing an anode and a side facing the cathode.

Table 3 below shows the benefits of a co-ex PE/PP-blend/PP structure where the blend comprises polypropylene and a about 5% of a styrenic elastomer, compared to a co-ex structure, PE/PP/PP that does not include the blend.

TABLE 3

| Property | Units | Co-ex PP/PP/PE | Co-ex PP/PP Blend/PE |
|---|---|---|---|
| Thickness | µm | 10.6 | 10.2 |
| Gurley JIS | s | 198 | 183 |
| Puncture Strength | gf | 188 | 203 |
| Normalized Puncture Strength | gf/µm | 17.7 | 19.9 |
| Porosity | % | 45.1 | 43.2 |
| MD Shrinkage 105° C. 1 hr | % | 5.5 | 4.4 |
| Electric Resist | Ωcm² | 1.0 | 0.9 |
| Elongation MD | % | 85 | 80 |
| Elongation TD | % | 838 | 789 |
| Tensile Str MD | Kgf/cm2 | 1591 | 1585 |
| Tensile Str TD | Kgf/cm2 | 169 | 137 |
| Dielectric Breakdown, Avg | V | 1377 | 1390 |
| Shutdown Temperature | °C | 136 | 135 |
| Static COF PP side | - | 0.35 | 0.34 |
| Static COF-PE side | - | 0.28 | 0.22 |
| Dynamic COF PP-side | - | 0.38 | 0.37 |
| Dynamic COF PE-side | - | 0.27 | 0.17 |

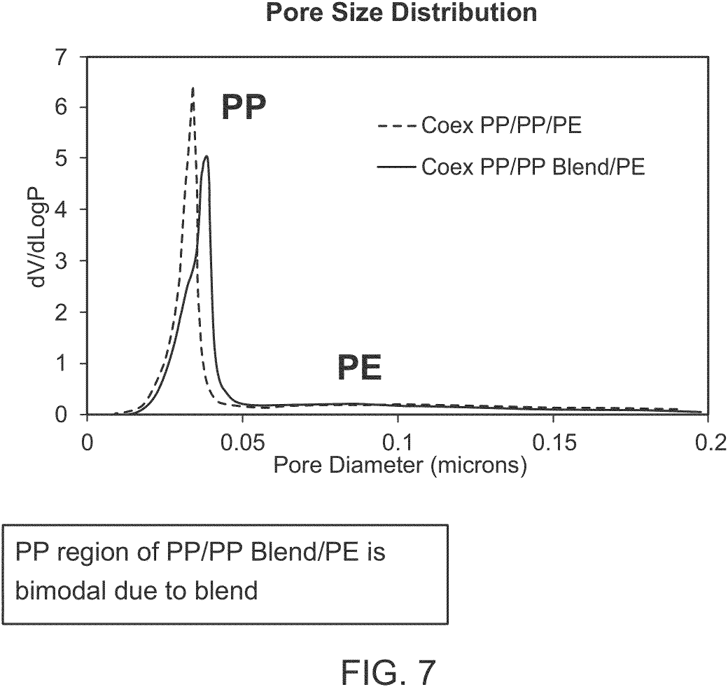

FIG. 7 shows the pore size distribution of a co-ex PE/PP-blend/PP product compared to that of a co-ex PE/PP/PP product. The pore size of the product with the blend is bi-modal. Benefits of these products include high strength due to high PP content, a PE layer for shutdown, even more improved strength in the product including the PP blend, reduced co-efficient due to PE on the outside, graduated pore size distribution, and the like. Graduated pore size in the PP-blend example—PE>PP-blend>PP—may help with dendrite growth mitigation if the PE layer faces the anode. Using PE in an outer layer provides the reduced co-efficient of friction desired for use in a cylindrical cell where pin removal force may be an issue. If mono-PE is used and the PE-layer is faced toward the anode, oxidation is not an issue.

1. A porous membrane comprising, two outer layers and optionally at least one inner layer, wherein the ratio of the thickness of one of the two outer layers to the other one of the two outer layers is from 1.1:1 to 4:1, from 1.1:1 to 3:1, or from 1.1:1 to 2:1.

2. (canceled)

3. (canceled)

4. (canceled)

5. The porous membrane of claim 1, comprising between 1 and 10 inner layers.

6. (canceled)

7. The porous membrane of claim 1, wherein the porous membrane is formed by a method that comprises:
laminating at least one of the two outer layers with at least one inner layer; or
co-extrusion of at least one of the two outer layers with at least one inner layer.

8. (canceled)

9. The porous membrane of claim 1,
wherein the outer two layers comprise, consist, or consist essentially of polypropylene and the at least one inner layer comprises, consists of, or consists essentially of polyethylene.

10. (canceled)

11. (canceled)

12. The porous membrane of claim 1,
wherein the total thickness of the porous membrane is from 5 to 30 microns, from 5 to 20 microns, from 5 to 15 microns, or from 5 to 10 microns.

13. (canceled)

14. (canceled)

15. (canceled)

16. A porous membrane comprising two outer layers and no inner layers, wherein the ratio of the thickness of one of the two outer layers to the other of the outer two layers is from 1.1:1 to 4:1, from 1.1:1 to 3:1, or from 1.1:1 to 2:1.

17. (canceled)

18. (canceled)

19. (canceled)

20. The porous membrane of claim 16, wherein the porous membrane is formed by a method that comprises:
laminating at least one of the two outer layers to the other of the two outer layers; or
co-extrusion of the two outer layers.

21. (canceled)

22. The porous membrane of claim 16, wherein the thicker of the two outer layers comprises, consists of, or consists essentially of polypropylene, and the thinner of the two outer layers comprises, consists of, or consists essentially of polyethylene.

23. (canceled)

24. (canceled)

25. The porous membrane of claim 16, wherein the total thickness of the porous membrane is from 5 to 30 microns, from 5 to 20 microns, from 5 to 15 microns, or from 5 to 10 microns.

26. (canceled)

27. (canceled)

28. (canceled)

29. A battery separator comprising, consisting of, or consisting essentially of the porous membrane of claim 1, wherein the battery separator has an electrochemical stability voltage equal to or above 4.2 v.s. Li/Li⁺, equal to or above 4.5 v.s. Li/Li⁺, or equal to or above 5.0 v.s. Li/Li⁺.

30. (canceled)

31. (canceled)

32. (canceled)

33. The battery separator of claim 29, wherein the porous membrane comprises a coating layer applied to the thinner of the two outer layers, wherein:
the coating layer may be at least one of the following: a ceramic coating, a polymer coating, and a shutdown coating; and/or
the coating layer has a thickness from 1 to 5 microns.

34. (canceled)

35. (canceled)

36. A secondary battery comprising the battery separator of claim 29 between an anode and a cathode, and having liquid electrolyte, wherein the thicker of the two outer layers of the porous membrane faces the cathode, and the thinner of the two outer layers of the porous membrane faces the anode.

37. A secondary battery comprising the battery separator of claim 33 between an anode and a cathode, wherein the coating layer faces the anode, and having liquid electrolyte.

38. A porous membrane comprising, two outer layers and at optionally least one inner layer, wherein at least one of the following: the average pore size, of one of the two outer layers is smaller than the average pore size of the other outer layer, the porosity of one of the two outer layers is smaller than the porosity of the other outer layer, and the tortuosity of one of the two outer layers is higher than the tortuosity of the other.

39. The porous membrane of claim 38, wherein the average pore size of one of the two outer layers is smaller than the average pore size of the other, and wherein the smaller average pore size may be from 0.005 to 0.5, from 0.005 to 0.05, from 0.025 to 0.05 microns, or from 0.025 to 0.04 microns, or wherein the smaller average pore size is between 1 and 30% smaller, between 1 and 25% smaller, between 1 and 20% smaller between 1 and 15% smaller, between 1 and 10% smaller, or between 1 and 5% smaller.

40. (canceled)

41. (canceled)

42. The porous membrane of claim 38, wherein the porosity of one of the two outer layers is lower than that of the other outer layer, and the lower porosity may be between 1 and 30% lower, between 1 and 25% lower, between 1 and 20% lower, between 1 and 15% lower, between 1 and 10% lower, or between 1 and 5% lower; and wherein the lower porosity may be between 5% and 50%, between 10% and 40%, between 15% and 30%, or between 20% and 25%.

43. (canceled)

44. The porous membrane of claim 38, wherein the tortuosity of one of the two outer layers is higher than that of the other outer layer, wherein the higher tortuosity may be greater than 1, greater than 1.1, greater than 1.2, greater than 1.3, greater than 1.4, greater than 1.5, greater than 1.6, greater than 1.7, greater than 1.8, greater than 1.9, or greater than 2.0.

45. (canceled)

46. A battery separator comprising, consisting of, or consisting essentially of the porous membrane of claim 38, wherein the battery separator may have an electrochemical stability voltage equal to or above 4.2 v.s. Li/Li⁺, equal to or above 4.5 v.s. Li/Li⁺, equal to or above 5.0v.s. Li/Li⁺.

47. (canceled)

48. (canceled)

49. (canceled)

50. The battery separator of claim 46, wherein the porous membrane comprises a coating layer applied to the outer layer having the smaller or larger average pore size, the higher or lower porosity, and/or the higher or lower tortuosity, wherein
the coating layer is at least one of the following: a ceramic coating, a polymer coating, and a shutdown coating; and/or
the coating layer has a thickness from 1 to 5 microns.

51. (canceled)

52. (canceled)

53. (canceled)

54. (canceled)

55. (canceled)

56. A secondary battery comprising the battery separator of claim 50 between an anode and a cathode, wherein the coating layer faces the anode, and having liquid electrolyte.

57. The porous membrane of claim 1, wherein the porous membrane is a multilayer porous membrane, the porous membrane is a multilayer porous membrane and two or more layers of the porous membrane are co-extruded, the porous membrane is a multilayer porous membrane comprising four or more layers, or the porous membrane is a multilayer porous membrane comprising four or more layers and two or more layers of the porous membrane are co-extruded.

58. (canceled)

59. (canceled)

60. (canceled)

61. The porous membrane of claim 1, wherein the porous membrane does not contain an inner layer, and one of the outer layers may comprise PE and another of the outer layers may comprise PP.

62. (canceled)

63. An asymmetric porous multilayer membrane comprising at least one polypropylene (PP)-containing layer and at least one polyethylene (PE)-containing layer, wherein a thickness ratio of the PP-containing layer or layers to the PE-containing layer or layers is in the range of 1.1:1 to 25:1, of 1.1:1 to 20:1, or of 4:1 to 10:1.

64. (canceled)

65. (canceled)

66. The asymmetric porous multilayer membrane of claim 63,
comprising two PP-containing layers and one PE-containing layer, wherein the layers are arranged in the following order PE/PP/PP or PE/PP-blend/PP; or
comprising two PP-containing layers and one PE-containing layer, wherein the layers are arranged in the following order PE/PP/PP or PE/PP-blend/PP, wherein the PP-containing layer contains the same or a different PP-containing material.

67. (canceled)

68. The asymmetric porous multilayer membrane of claim 63, wherein two or more PP-containing layers are present and the PP-containing layers have the same or a different PP-containing material.

69. The asymmetric porous multilayer membrane of claim 63, wherein a PP-containing material of the PP-containing layer or layers comprises a single polypropylene, a mixture of two or more different polypropylenes, a single polypropylene and an additional component, or a mixture of two or more different polypropylenes and an additional component, wherein:
the additional component may be at least one of a polymer other than a polypropylene, an elastomer, or combinations thereof; or
the additional component may be a styrenic elastomer.

70. (canceled)

71. (canceled)

72. The asymmetric porous multilayer membrane of claim 63, wherein:
two or more PE-containing layers are present, and the PE-containing layers may have the same or different PE-containing material;
the membrane having the following structure PE/PE/PP/PP/PP/PP, wherein PE is a PE-containing layer and PP is a PP-containing layer;
the membrane having the following structure PE/PE/PP/PP/PP/PP, wherein PE is a PE-containing layer and PP is a PP-containing layer;
the membrane having the following structure, PE/PE/PE/PP/PP/PP/PP/PP/PP, wherein PE is a PE-containing layer and PP is a PP-containing layer;
the membrane having the following structure,
PE/PE/PE/PE/PP/PP/PP/PP/PP/PP/PP/PP,
wherein PE is a PE-containing layer and PP is a PP-containing layer; or
the membrane having the following structure PE/PE/PE/PE/PE/PP/PP/PP/PP/PP/PP/PP/PP/PP/PP, wherein PE is a PE-containing layer and PP is a PP-containing layer.

73. (canceled)

74. (canceled)

75. (canceled)

76. (canceled)

77. The asymmetric porous multilayer membrane of claim 63, wherein:
the membrane is formed by coextruding two or more of the layers;
the membrane is formed by co-extruding three or more layers; and/or
the membrane is a dry-process membrane.

78. (canceled)

79. The asymmetric porous multilayer membrane of claim 66, wherein all three layers, PE/PP/PP or PE/PP-blend/PP, are coextruded.

80. (canceled)

81. A battery separator comprising the asymmetric porous multilayer membrane of claim 63, wherein:
only one outermost layer of the asymmetric porous multilayer membrane is a PE-containing layer;
only one outermost layer of the asymmetric porous multilayer membrane is a PE-containing layer, and a ceramic coating or cross-linked coating is on the PE-containing outermost layer; or
the battery separator comprises one or more selected from a ceramic coating and a cross-linked coating on at least one side thereof.

82. (canceled)

83. (canceled)

84. A battery comprising an anode, a cathode, a liquid electrolyte, and the battery separator of claim 81, and the outermost layer that is also a PE-containing layer may face or is closest to an anode.

85. (canceled)

86. (canceled)

87. An asymmetric porous multilayer membrane comprising at least one polypropylene (PP)-containing layer and at least one polyethylene (PE)-containing layer, wherein a thickness ratio of the PE-containing layer or layers to the PP-containing layer or layers is in the range of 1.1:1 to 25:1, in the range of 1.1:1 to 20:1, or in the range of 4:1 to 10:1.

88. (canceled)

89. (canceled)

90. A battery separator comprising, consisting of, or consisting essentially of the porous membrane of claim 16, wherein the battery separator has an electrochemical stability voltage equal to or above 4.2 v.s. Li/Li⁺, equal to or above 4.5 v.s. Li/Li⁺, or equal to or above 5.0 v.s. Li/Li⁺.

91. The porous membrane of claim 38, wherein the porous membrane is a multilayer porous membrane, the porous membrane is a multilayer porous membrane and two or more layers of the porous membrane are co-extruded, the porous membrane is a multilayer porous membrane comprising four or more layers, or the porous membrane is a multilayer porous membrane comprising four or more layers and two or more layers of the porous membrane are co-extruded.

92. The porous membrane of claim 38, wherein the porous membrane does not contain an inner layer, and one of the outer layers may comprise PE and another of the outer layers may comprise PP.
